(19) United States
(12) Patent Application Publication
(10) Pub. No.: US 2014/0269172 A1
(43) Pub. Date: Sep. 18, 2014

(54) ANTI-FOULING SEISMIC STREAMER

(71) Applicant: WESTERNGECO L.L.C., HOUSTON, TX (US)

(72) Inventors: ROBERT SETH HARTSHORNE, BURWELL (GB); NILS HALVOR HEIEREN, OSLO (NO); ANDERS NESHEIM, OSLO (NO); GARY JOHN TUSTIN, SAWSTON (GB)

(73) Assignee: WESTERNGECO L.L.C., HOUSTON, TX (US)

(21) Appl. No.: 14/207,122

(22) Filed: Mar. 12, 2014

Related U.S. Application Data
(60) Provisional application No. 61/787,534, filed on Mar. 15, 2013.

(51) Int. Cl. G01V 1/20; B29C 47/00; B29C 47/02; B29C 47/06

(52) U.S. Cl. CPC G01V 1/201; B29C 47/065; B29C 47/0023; B29C 47/02; G01V 1/38
USPC 367/15; 264/171.13

(57) ABSTRACT

A seismic streamer and associated method are provided. The seismic streamer may include a seismic streamer core having a cylindrical configuration. A melt-processable thermoplastic layer may be coupled with the seismic streamer core, the melt-processable thermoplastic layer being extruded to form a first tube. An elastomeric layer may be coupled with the melt-processable thermoplastic layer, the elastomeric layer being extruded to form a second tube.

### CROSS-REFERENCE TO RELATED APPLICATION

This application claims the benefit of U.S. Provisional Patent Application Ser. No. 61/787,534 filed Mar. 15, 2013, which is incorporated herein by reference in its entirety.

### BACKGROUND

Seismic data acquisition may be conducted by towing some number of streamer sections behind a vessel. The streamer sections may have varying types of construction and sensor mounting in the streamer. Data recorded on these streamers may be stored in memory on the towing vessel. Ocean bottom cable (OBC) is another recording body used in seismic data acquisition. OBC differs from towed marine because the cables remain stationary on the sea floor and the data may be recorded either on a dedicated recording buoy or a recording vessel.

In some cases, seismic exploration campaigns may be scheduled to last several months and often one vessel may spend a period of activity in one geographical location before moving to a new location to begin a further period of seismic data acquisition. Given the length of the streamer networks, returning (e.g., by reeling) the streamers back onto the vessel is generally avoided as the process is operationally difficult and time consuming. As a result, the streamer arrays may spend consecutive months (often 6-12) immersed in sea water. Moreover, the streamers are towed below the surface of the water and are towed at various speeds (e.g., less than 5 knots). Therefore, seismic streamers are prone to fouling by marine organisms such as ‘slime’ and barnacles.

This fouling of seismic streamers can generate several problems. For example, the drag of seismic streamers is increased, which consequently results in increased fuel consumption. The induced increase in mass on the streamer can cause direct and indirect damage due to increased strain on stress members. Hydrodynamic flow noise is created that in severe cases may reduce the acoustic signal/noise performance of the acquisition system. Personnel are put at risk as work boats need to be deployed in order to perform manual removal of the fouling organisms using scraping devices. The process is highly time consuming and results in economically costly lost-production time. Moreover, due to the sharp nature of the hand-held devices used to physically remove fouling organisms, the process is often coupled with damage to the integrity of the seismic streamer tubing.

### SUMMARY OF DISCLOSURE

In one implementation, a seismic streamer is provided. The seismic streamer may include a seismic streamer core having a cylindrical configuration. The seismic streamer may further include a melt-processable thermoplastic layer coupled with the seismic streamer core, the melt-processable thermoplastic layer extruded to form a first tube. The seismic streamer may also include an elastomeric layer coupled with the melt-processable thermoplastic layer, the elastomeric layer extruded to form a second tube.

In some implementations, the melt-processable thermoplastic layer may include a thermoplastic polyurethane block co-polymer. The first tube and/or the second tube may be flexible. The melt-processable thermoplastic layer may include a fluoro-diol polymer. The melt-processable thermoplastic layer may include a silicone-diol polymer. An adhesive layer may be coupled with the melt-processable thermoplastic layer and/or the elastomeric layer. The first tube and/or the second tube may include a rigid core. The elastomeric layer may include a first thickness and the melt-processable thermoplastic layer may include a second thickness, the first thickness being less than the second thickness. The elastomeric layer may include a Young's modulus between 0.5-7.5 MPa. The melt-processable thermoplastic layer and the elastomeric layer may be co-extruded. The elastomeric layer may include a fluoro-diol polymer and/or a silicone-diol polymer.

In another implementation, a method of making a seismic streamer is provided. The method may include providing a seismic streamer core having a cylindrical configuration. The method may further include forming a melt-processable thermoplastic layer that is in contact with a portion of the seismic streamer core, the melt-processable thermoplastic layer forming a first tube. The method may also include forming an elastomeric layer that is in contact with a portion of the melt-processable thermoplastic layer, the elastomeric layer forming a second tube.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Embodiments of the present disclosure are described with reference to the following figures.

FIG. 1 illustrates a sea vessel that may deploy one or more anti-fouling streamers in accordance with one or more embodiments of the present disclosure;

FIG. 2 illustrates a portion of an anti-fouling streamer in accordance with one or more embodiments of the present disclosure;

FIG. 3 illustrates an embodiment of an anti-fouling streamer in accordance with one or more embodiments of the present disclosure;

FIG. 4 illustrates an embodiment of an anti-fouling streamer in accordance with one or more embodiments of the present disclosure;

FIG. 5 illustrates a schematic depicting an example of contact angle measurement protocol for TPU plaques in accordance with one or more embodiments of the present disclosure;

FIG. 6 illustrates a schematic depicting the contact angle impact on the degree of bio-fouling in accordance with one or more embodiments of the present disclosure;

FIG. 7 illustrates a schematic depicting a desired surface energy for modified TPU to reduce bio-fouling in accordance with one or more embodiments of the present disclosure;

FIG. 8 illustrates a schematic depicting the surface energy of fluoro-modified and silyl-modified TPU samples in accordance with one or more embodiments of the present disclosure;

FIG. 9 illustrates a schematic depicting the surface energy of modified TPU systems plotted on a Baier Curve in accordance with one or more embodiments of the present disclosure;

FIG. 10 illustrates SEM images of the surface and cross-section of Fluoroflake modified TPU in accordance with one or more embodiments of the present disclosure;

FIG. 11 illustrates ECX analysis of Fluroflake modified TPU in accordance with one or more embodiments of the present disclosure;

FIG. 12 illustrates XPS analysis of Fluroflake modified TPU in accordance with one or more embodiments of the present disclosure;

FIG. 13 illustrates XPS analysis of Fluroflake modified TPU in accordance with one or more embodiments of the present disclosure; and

FIG. 14 is a flow diagram of a process in accordance with one or more embodiments of the present disclosure.

Like reference symbols in the various drawings may indicate like elements.

### DETAILED DESCRIPTION

Embodiments provided herein are directed towards a seismic streamer that may include anti-fouling properties. Also included are methods of making anti-fouling seismic streamers. Embodiments may relate to analysis via seismic methods but can also be applied to any field implementing seismic data acquisition in a marine environment.

FIG. 1 illustrates a sea vessel 100 that may include a reel or spool 104 for deploying a streamer 102, which may be a cable-like structure having a number of sensors 103 for performing a subterranean survey of a subterranean structure 114 below a sea floor 112. A portion of streamer 102, and more particularly, sensors 103, may be deployed in a body of water 108 underneath a sea surface 110. Streamer 102 may be towed by the sea vessel 100 during a seismic operation.

In an alternative implementation, instead of using a streamer that is towed in the water by sea vessel 100, a seabed cable may be used instead, where the seabed cable may be, for example, deployed from a reel on the sea vessel and/or laid on a sea floor 112.

In yet another implementation, a data storage device may be associated with a streamer that may be deployed vertically from either a buoy, stationary underwater or surface autonomous vehicle, and/or a structure rising up from the sea floor. This type of arrangement may be referred to as a vertical cable survey. Accordingly, this type of arrangement may render recording buoys and surface connections unnecessary.

In the following, the term “streamer” is intended to cover either a streamer that is towed by a sub-sea or sea surface vessel or non-towable streamers such as a seabed cable laid on the sea floor 112 or those that may be deployed vertically in the water column.

In some embodiments, streamer 102 may have a length of 15 m-100 m (e.g., 30 meters or less). However, it should be noted that streamers of any length may be used without departing from the scope of the present disclosure.

Also depicted in FIG. 1 are a number of signal sources 105 that may produce signals propagated into the body of water 108 and into subterranean structure 114. The signals may be reflected from layers in subterranean structure 114, including a resistive body 116 that can be any one of a hydrocarbon-containing reservoir, a fresh water aquifer, an injection zone and so forth. Signals reflected from resistive body 116 may be propagated upwardly toward sensors 103 for detection by the sensors. Measurement data may be collected by sensors 103, which may store the measurement data and/or transmit the measurement data back to data storage device 106.

In some embodiments, sensors 103 may be seismic sensors, which may be implemented with acoustic sensors such as hydrophones, geophones, and/or fiber optic based sensor systems. The signal sources 105 may be seismic sources, such as air guns, marine vibrators and/or explosives. In an alternative implementation, the sensors 103 may be electromagnetic (EM) sensors 103, and signal sources 105 may be EM sources that generate EM waves that are propagated into subterranean structure 114.

Although not shown in FIG. 1, streamer 102 may further include additional sensors (e.g., depth sensors), which may be used to detect a position of respective sections of streamer 102. In accordance with some embodiments, data from these additional sensors may be sent back to data storage device 106 to update information regarding which sections of streamer 102 are in body of water 108, and which sections of streamer 102 are outside the body of water.

In some embodiments, streamer 102 may include any number, type and configuration of sensors. Some of these may include, but are not limited to, hydrophones, geophones, particle displacement sensors, particle velocity sensors, accelerometers, pressure gradient sensors or combinations thereof.

In some embodiments, streamer 102 may include a multi-component streamer, which means that streamer 102 may contain particle motion sensors and pressure sensors. The pressure and particle motion sensors may be part of a multi-component sensor unit. Each pressure sensor may be configured to detect a pressure wavefield, and each particle motion sensor may be configured to detect at least one component of particle motion that is associated with acoustic signals that are proximate to the sensor. Examples of particle motions include one or more components of a particle displacement, one or more components (inline (x), crossline (y) and vertical (z) components of a particle velocity and one or more components of a particle acceleration. A more thorough discussion of particle motion sensors may be found in U.S. Patent Publication 2012/0082001, which is incorporated by reference herein in its entirety.

FIG. 2 shows one particular embodiment depicting an example of a portion of streamer 102, including sections 200A, 200B, and 200C. In this particular embodiment, section 200A may include a corresponding sensor 103 (such as a seismic sensor) for detecting subterranean features. Sensor 103 may be deployed intermittently (e.g., alternating sections) throughout streamer 102 in one example. In some embodiments, each section may have a corresponding sensor 103 for detecting subterranean features.

In the ensuing discussion, reference is made to seismic sensors. Note, however, in other implementations, the sensors used for detecting subterranean features may include any suitable sensors or sensing equipment. Note also that the arrangement in FIG. 2 is an example arrangement. Different arrangements may be used in other implementations. For example, the recording sensors may be within 10's of meters to the towing vessel Global Navigation Satellite System (“GNSS”) antenna. Streamer 102 may also include additional equipment that is not shown in FIG. 2, for example, one or more data storage devices (e.g., data storage device 106) as is discussed in further detail below.

Section 200A may further include a second sensor 202A, which in some embodiments is a depth sensor to detect the depth of the section of the streamer 102 in the body of water 108. Each of the other sections 200B, 200C depicted in FIG. 2 also includes a corresponding second sensor 202B, 202C (e.g., depth sensors).

Section 200A may further include steering device 204 to help steer streamer 102 in the body of water. Steering device 204 may include control surfaces 206 (in the form of blades or wings) that may be rotatable about a longitudinal axis of streamer 102 to help steer streamer 102 in a desired lateral direction. Steering device 204 may be provided intermittently (e.g., alternating sections) throughout streamer 102.

In some implementations, steering device 204 may include a battery (or other power source) 208 that may be used to power the steering device 204. Battery 208 may also be used to power the depth sensor 202A in the section 200A, as well as depth sensors 202B, 202C in other sections 200B, 200C that are relatively close to the section 200A containing the steering device 204. Power from the battery 208 may be provided over electrical conductor(s) 210 to the depth sensors 202A, 202B, 202C. Battery 208 may also be configured to power a data storage device (e.g., 106, 300, etc.) and in some cases battery 208 may be included within the data storage device. In alternative implementations, power may be provided from an alternative source, such as from the sea vessel 100, solar charger associated with a buoy, over an electrical cable 212 (or fiber optic cable) that may be routed through the streamer 102. To derive power from a fiber optic cable, each sensor 202 would include a conversion circuit to convert optical waves into electrical power. An alternative source of power may include a wave powered generator. A more thorough discussion of wave generated power may be found in U.S. Patent Publication 2009/0147619, which is incorporated by reference herein in its entirety. Accordingly, the data storage device described herein may include a battery to store such wave motion generated power.

In accordance with some embodiments, depth sensors 202 (202A, 202B, 202C shown) may be used to detect which sections 200 of streamer 102 are deployed in the body of water 108. Depth sensors 202 may provide data regarding whether corresponding sections are in the body of water 108 by communicating the data over a communications link (e.g., electrical or fiber optic cable) 212 that is run along the length of the streamer 102 to the reel 104 on the sea vessel 100 and/or to data storage device 106. The data provided from depth sensors 202 may be received at and stored within data storage device 106.

As discussed above, in some embodiments, streamer 102 may include anti-fouling properties. Accordingly, the teachings of the present disclosure include a method of preventing the adhesion of marine organisms to the outer surfaces of seismic streamers. Embodiments included herein provide a streamer tubing material that may be manufactured from a fluorinated and/or silicone-derivatised thermoplastic polyurethane (TPU). Incorporation of fluorine or silicone into the thermoplastic polyurethane (TPU) backbone may occur during the polyurethane synthesis reaction and may yield a chemically modified TPU that can be used to produce streamer tubing with unaffected mechanical properties but lower surface energy relative to TPU. This may allow for the co-extrusion of a fluoro or silicone elastomer (e.g., TPU-based) over the skin. In this way, embodiments included herein may allow for a mechanically sound streamer skin covered with a low surface energy, low Young's modulus material having good adhesion between the two layers.

Referring now to FIG. 3, an embodiment depicting an illustration of a method of fluorine incorporation into a thermoplastic polyurethane block co-polymer is provided. Substitution of a typical chain extender (e.g., non-fluorinated 302) for a fluorinated chain extender 304, may yield a TPU material that can be extruded to produce a seismic streamer section as indicated by the cross-sectional view of anti-fouling seismic streamer 306.

Embodiments included herein may disperse fluorine both through the bulk matrix and at the surface of the tubing (shown by grey shading). The modified (hydrophobic) surface imparts low surface energy properties to the seismic streamer making it suitable for co-extrusion with a silicon or fluoro-elastomer.

In some embodiments, the anti-fouling seismic streamer described herein may include a streamer skin (or streamer tubing) that can resist adhesion of marine organisms. Some marine organisms may include, but are not limited to, marine slime, barnacles, etc. Accordingly, in some embodiments, heteroatoms, which may include, but are not limited to, fluorine and silicon, may be incorporated within the seismic streamer (e.g., within seismic streamer tubing during the tubing manufacturing process) effectively lowering the surface energy of the TPU but maintaining the mechanical properties of the TPU such that it is able to perform its function as a streamer skin. In this way, the anti-fouling seismic streamer described herein may involve the application of an elastomeric material via co-extrusion of this material over the streamer skin during the manufacturing process. Some embodiments described herein may also be configured to provide a skin that can be used to contain the acoustic equipment of a towed sonar line array and retain the mechanical and physical constraints linked with the streamer tubing inventory that is currently in operation.

In some embodiments, the anti-fouling seismic streamer described herein may include a seismic streamer skin that may be manufactured from melt-processable thermoplastic polyurethane (TPU) block co-polymer that can be extruded to form a self-supporting flexible tube with a co-extruded outer layer suitable for foul-release purposes.

Referring now to FIG. 4, an embodiment of an anti-fouling seismic streamer 400 consistent with the teachings of the present disclosure is provided. Streamer 400 may include seismic streamer core 402. Streamer core 402 may include some of the components discussed above in FIGS. 1-3. In some embodiments, streamer core 402 may have a cylindrical configuration, however, any suitable shape may be employed without departing from the scope of the present disclosure. Streamer 400 may also include a melt-processable thermoplastic layer 404. Layer 404 may be coupled with the seismic streamer core 402. For example, thermoplastic layer 404 may be extruded to form a first tube or skin that may be in contact with seismic streamer core 402. Thermoplastic layer 404 may be coupled with elastomeric layer 406 as is shown in FIG. 4. Elastomeric layer 406 may be extruded to form a second tube or skin that may be in contact with thermoplastic layer 404.

In some embodiments, melt-processable thermoplastic layer 404 may include a thermoplastic polyurethane block co-polymer such as that shown in FIG. 3. Portions of streamer 400 may be rigid and some portions may be flexible in nature. For example, layer 404, layer 406 and streamer core 402 may be flexible. Layer 404, layer 406 and streamer core 402 may have a rigid configuration. In some cases, layers 404 and 406 may be flexible and streamer core 402 may be rigid.

In some embodiments, melt-processable thermoplastic layer 404 may include a fluoro-diol and/or a silicone-diol polymer. These polymers are provided merely by way of example as other polymers are also within the scope of the present disclosure.

In some embodiments, elastomeric layer 406 may include a first thickness and the melt-processable thermoplastic layer 404 may include a second thickness. For example, and as shown in FIG. 4, in some cases the thickness of elastomeric layer 406 may be less than that of thermoplastic layer 404. In some embodiments, elastomeric layer 406 may have a Young's modulus between 0.5-7.5 MPa and may include fluoro-diol and/or silicone-diol polymers.

In some embodiments, additional layers may also be included. For example, an adhesive layer may be coupled with melt-processable thermoplastic layer 404 and/or elastomeric layer 406. Melt-processable thermoplastic layer 404 and elastomeric layer 406 may be co-extruded as is discussed in further detail hereinbelow.

Thermoplastic polyurethanes are a versatile group of multi-phase segmented polymers that have excellent mechanical and elastic properties, good hardness and high abrasion and chemical resistance. Generally, polyurethane block co-polymers are comprised of a low glass transition or low melting ‘soft’ segment and a rigid ‘hard segment’, which often has a glassy T_{g} or crystalline melting point well above room temperature.

Thermoplastic polyurethanes used in seismic streamers are relatively hydrophilic materials which are demonstrated by the fact that these materials have an air-water contact angle (θ) less than 90°. The contact angle of a surface (as determined using water and/or methylene iodide) can be used to derive the surface energy of the material using a suitable protocol, such as the Owens-Wendt geometric mean method shown in FIG. 5, which gives a good idea of the tendency of the surface to bio-foul as is shown in FIG. 6.

A high surface energy is one of the main contributing factors to the propensity of streamer surfaces to be fouled by marine organisms. The type of fouling observed depends on the area of the world and the temporal climate but fouling can vary from algal colonization to barnacle infestation or combinations thereof. Use of coatings and paints has been demonstrated to be very effective against these types of infestation, particularly against barnacle colonization, by far the most prevalent form of fouling for seismic streamers. In some embodiments, reducing the surface energy of the polyurethane streamer allows for the application of anti-fouling coatings or paints with good adherence properties. As shown in FIG. 7, a surface energy reduction from the current value (around 43 mN/m) to between 15 to 25 mN/m as these values are compatible with the application of the aforementioned paints and coatings.

Modification of the streamer surface post fabrication is time-consuming and is not cost effective. Coatings on the streamer may require several applications (or ‘coats’) by brush, spray or via a dip-coating procedure and often require a ‘tie-coat’ (or intermediate coat) to be applied between the streamer surface and the outer coating layer to aid adhesion. Despite this provision the resulting coating layers have a tendency to delaminate and ‘peel off’ the streamer as the wettability/surface energy of the substrate and coating materials are mis-matched.

Embodiments of the anti-fouling seismic streamer described herein may be used to produce a modified TPU that has the required mechanical and acoustic properties. Due to the low surface energy, co-extrusion of a fluoro- or silicone elastomer onto the streamer may be used.

Accordingly, integrating materials into the chemistry of the streamer during the production process may allow for better adhesion of a co-extruded layer and may be used to produce a modified streamer having enhanced anti-fouling properties. Modifying the streamer alone may impart some anti-fouling properties on the skin. However, the present disclosure may maintain the mechanical properties the young's modulus of these materials and the surface energy may not be as low as those achieved using co-extruded coatings based on high levels of silicon or fluoro-based polymers. The modified TPU described herein may be readily amenable to being coated with these materials during the production process.

Incorporation of silicone or fluorine into the TPU may lower the surface energy of the streamer by altering the wettability of the material. In each case, this may yield a thermoplastic polyurethane block co-polymer which may exhibit a two-phase microstructure. Fluorine (e.g., using materials such as Fluoro-link) or silicone (e.g., using Silmer-OH amongst others) may be dispersed homogenously throughout the TPU. In some cases, being localised predominantly in the hard, rigid segments (e.g., via the hydrophobically derivatised chain extender route, glassy or semicrystalline domains) and/or in the polyol, amorphous segments if using the derivatised polyol approach.

TPU plaques incorporating both silicon and fluorine diols were produced. Both of these materials were compared against non-modified TPU control materials. The contact angles of the three test plaques were measured and the surface energy calculated utilizing the following equation:

(1+cos(θ))γ_{LV}=2√(γ_{S}^{D}γ_{L}^{D})+2√(γ_{S}^{P}γ_{L}^{P}) EQUATION 1:

where
(water: γ_{LV}=72.80; γ_{L}^{D}=21.80; γ_{L}^{P}=51.00; methylene iodide: γ_{LV}=50.80; γ_{L}^{D}=50.80; γ_{L}^{P}=0)

The surface energy of the new materials was found to be in the target range, between 15 to 30 mN/m, compared to the control which was outside this value (35 mN/m). The data for all systems is provided in FIGS. 8-9. Although good for foul-release these materials are not ideal as the surface energy could be lower and the Young's modulus also could be lower. These materials though need to maintain the mechanical properties required for seismic streamers, which these materials do.

In this way, there many different sets of mechanical properties relevant for a material used as a seismic streamer skin. These may include, but are not limited to, the properties relating to signal transfer and the properties relating to the mechanical robustness. Both the hardness and the stiffness of the TPU affect the signal transfer of the skins. The Shore A hardness of the modified materials is 93±7 (ASTM D2240), while the apparent modulus (found from the transitional nominal stress and strain) is in the range of 30-70 MPa (ISO 527-2).

As the streamer skin should be able to take a certain amount of abuse, mechanical properties such as abrasion, tear and puncture resistance are analyzed. Puncture impact behavior of the modified skins show a peak force higher than 2500 N and a total energy of at least 50 J (ISO 6603-2), while the tear resistance may be higher than 80 N/mm (ASTM D624). In addition, the modified skins (both silicone and fluorine modified) interestingly show around a 50% increase in abrasion resistance (ASTM D638-08). Also, the maximum tensile stress and the maximum elongation at break are improved in the modified skins, with up to a 20% increase in both properties (ISO 527-2).

Application of silicone and fluorine elastomers to TPU is difficult and the durability of these systems is low. Co-extrusion of a fluoro-elastomer or silicone-elastomer, for example TPU based, over the already modified TPU skin may provide a mechanically robust system with good foul-release properties. The thin outer-coating may include an approximate Young's modulus between 0.5 and 7.5 MPa in order to have the optimum foul release properties.

Referring now to FIGS. 10-13, a number of test results are provided. FIG. 10 illustrates SEM images of the surface and cross-section of Fluoroflake modified TPU in accordance with one or more embodiments of the present disclosure. FIG. 11 illustrates ECX analysis of Fluroflake modified TPU in accordance with one or more embodiments of the present disclosure. FIG. 12 illustrates XPS analysis of Fluroflake modified TPU in accordance with one or more embodiments of the present disclosure. FIG. 13 illustrates XPS analysis of Fluroflake modified TPU in accordance with one or more embodiments of the present disclosure.

Accordingly, anti-fouling coatings may be more effective when applied to a modified TPU, where the surface energy of the systems has been reduced to decrease the mismatch with the outer-coating. The use of hydrophobic chain extenders in polyurethane may be limited with regard to the amount of modification that can be achieved whilst maintaining a mechanically sound system. To enhance the amount of hydrophobicity on the surface of the streamer, embodiments of the present disclosure provide for the manufacture of the streamer from a modified TPU and for the co-extrusion of an outer layer composed of a low molecular weight TPU system with high hetero-atom content, as shown in FIG. 4.

In some embodiments, methods of co-extrusion, particularly co-extruding materials that are chemically incompatible have been shown. Several have been shown that shown having co-extrusion TPU with materials such as PVDF. These final materials may generate a weak boundary layer due to the incompatibility of the two polymers used. As discussed above, embodiments disclosed herein may modify the base material to maintain the desired properties for seismic streamers and may reduce the surface energy allowing for the co-extrusion discussed above. Moreover, by reducing the incompatibilities within the chemistry, embodiments of the present disclosure may increase the durability of the boundary layer. The outer layer may provide for foul-release as the inner part of the streamer may provide the mechanical and physical properties required for streamer skins.

Referring now to FIG. 14, an embodiment depicting a flowchart 1400 consistent with an embodiment of the present disclosure is provided. Flowchart 1400 may include a method of making an anti-fouling seismic streamer. The process may include providing 1402 a seismic streamer core having a cylindrical configuration and forming 1404 a melt-processable thermoplastic layer that is in contact with at least a portion of the seismic streamer core, the melt-processable thermoplastic layer forming a first tube. The process may further include forming 1406 an elastomeric layer that is in contact with at least a portion of the melt-processable thermoplastic layer, the elastomeric layer forming a second tube.

The flowchart and block diagrams in the figures illustrate the architecture, functionality and operation of possible implementations of systems, methods and computer program products according to various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As used in any embodiment described herein, the term “circuitry” may comprise, for example, singly or in any combination, hardwired circuitry, programmable circuitry, state machine circuitry, and/or firmware that stores instructions executed by programmable circuitry. It should be understood at the outset that any of the operations and/or operative components described in any embodiment or embodiment herein may be implemented in software, firmware, hardwired circuitry and/or any combination thereof.

The terminology used herein is for the purpose of describing particular embodiments and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Although a few example embodiments have been described in detail above, those skilled in the art will readily appreciate that many modifications are possible in the example embodiments without materially departing from the anti-fouling seismic streamer described herein. Accordingly, such modifications are intended to be included within the scope of this disclosure as defined in the following claims. In the claims, means-plus-function clauses are intended to cover the structures described herein as performing the recited function and not just structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

Having thus described the disclosure of the present application in detail and by reference to embodiments thereof, it will be apparent that modifications and variations are possible without departing from the scope of the disclosure defined in the appended claims.

What is claimed is:

1. A seismic streamer comprising:
a seismic streamer core having a cylindrical configuration;
a melt-processable thermoplastic layer coupled with the seismic streamer core, the melt-processable thermoplastic layer extruded to form a first tube; and
an elastomeric layer coupled with the melt-processable thermoplastic layer, the elastomeric layer extruded to form a second tube.

2. The seismic streamer of claim 1, wherein the melt-processable thermoplastic layer includes a thermoplastic polyurethane block co-polymer.

3. The seismic streamer of claim 1, wherein at least one of the first tube, the second tube, and the streamer core is flexible.

4. The seismic streamer of claim 1, wherein the melt-processable thermoplastic layer includes a fluoro-diol polymer.

5. The seismic streamer of claim 1, wherein the melt-processable thermoplastic layer includes a silicone-diol polymer.

6. The seismic streamer of claim 1, further comprising:
an adhesive layer coupled with at least one of the melt-processable thermoplastic layer and the elastomeric layer.

7. The seismic streamer of claim 1, wherein at least one of the first tube, the second tube and the streamer core includes a rigid core.

8. The seismic streamer of claim 1, wherein the elastomeric layer includes a first thickness and the melt-processable thermoplastic layer includes a second thickness, the first thickness being less than the second thickness.

9. The seismic streamer of claim 1, wherein the elastomeric layer has a Young's modulus between 0.5-7.5 MPa.

10. The seismic streamer of claim 1, wherein the melt-processable thermoplastic layer and the elastomeric layer are co-extruded.

11. The seismic streamer of claim 1, wherein the elastomeric layer includes at least one of a fluoro-diol polymer and a silicone-diol polymer.

12. A method of making a seismic streamer comprising:
providing a seismic streamer core having a cylindrical configuration;
forming a melt-processable thermoplastic layer that is in contact with at least a portion of the seismic streamer core, the melt-processable thermoplastic layer forming a first tube; and
forming an elastomeric layer that is in contact with at least a portion of the melt-processable thermoplastic layer, the elastomeric layer forming a second tube.

13. The method of making a seismic streamer of claim 12, wherein the melt-processable thermoplastic layer includes a thermoplastic polyurethane block co-polymer.

14. The method of making a seismic streamer of claim 12, wherein at least one of the first tube, the second tube, and the streamer core is flexible.

15. The method of making a seismic streamer of claim 12, wherein the melt-processable thermoplastic layer includes a fluoro-diol polymer.

16. The method of making a seismic streamer of claim 12, wherein the melt-processable thermoplastic layer includes a silicone-diol polymer.

17. The method of making a seismic streamer of claim 12, further comprising:
forming an adhesive layer with at least one of the melt-processable thermoplastic layer and the elastomeric layer.

18. The method of making a seismic streamer of claim 12, wherein at least one of the first tube, the second tube and the streamer core includes a rigid core.

19. The method of making a seismic streamer of claim 12, wherein the elastomeric layer includes a first thickness and the melt-processable thermoplastic layer includes a second thickness, the first thickness being less than the second thickness.

20. The method of making a seismic streamer of claim 12, further comprising:
co-extruding the melt-processable thermoplastic layer and the elastomeric layer.
